(19) United States
(12) Patent Application Publication
(10) Pub. No.: US 2014/0066118 A1
(43) Pub. Date: Mar. 6, 2014

(54) SYSTEMS AND METHODS FOR SENDING FLOOR REQUESTS IN PARALLEL WITH TRAFFIC CHANNEL SETUP IN WIRELESS NETWORKS

(71) Applicant: MADHUSUDAN PAI, BANGALORE (IN)

(72) Inventor: MADHUSUDAN PAI, BANGALORE (IN)

(73) Assignee: MOTOROLA SOLUTIONS, INC., Schaumburg, IL (US)

(21) Appl. No.: 13/600,450

(22) Filed: Aug. 31, 2012

(51) Int. Cl. H04W 4/10

(52) U.S. Cl. 455/518

(57) ABSTRACT

A mobile device-based method, a controller and wireless network-based method, and a mobile device enable sending Push-to-Talk (PTT) floor requests in parallel with traffic channel (TCH) setup in wireless networks thereby reducing delay associated with idle devices in Push-to-Talk over Cellular (PoC) systems. For example, the floor requests can be sent concurrently with TCH setup using Data over Signaling in Code division multiple access (CDMA) Data Only (DO) networks or variants thereof.

### FIELD OF THE DISCLOSURE

The present disclosure relates generally to wireless network and push-to-talk (PTT) systems and methods such as push-to-talk over cellular (POC), and more particularly to systems and methods for sending floor requests in parallel with traffic channel (TCH) setup in POC wireless networks.

### BACKGROUND

Wireless radios are utilized to various applications. For example, two-way radios are commonly used in public safety applications. In two-way radio operation, each radio handset can include a knob with various settings for groups, e.g. group G1, G2, etc., and the setting of the knob is determinative of which group the radio handset is currently participating in, i.e. the different groups may included different frequencies F1, F2, etc. Specifically, each of the groups functions as a narrowband push-to-talk (PTT) channel. Radio handsets are moving to broadband networks, i.e. either dedicated operation over such networks, use of such networks when roaming, etc. Exemplary broadband networks include Code division multiple access (CDMA) networks and variants thereof, Long Term Evolution (LTE), Evolution-Data Optimized or Evolution-Data Only (EV-DO, EV, EVDO, DO etc.), etc. With this move to broadband networks, the concept of the knob on the radio handset no longer applies. However, different groups can be defined within various Session Initiation Protocol (SIP) constructs thereby allowing a mobile device to affiliate with multiple groups at a time. Conventionally, when a mobile device is affiliated to a group and is in a broadband network, the mobile device may be dormant after a certain amount of time following expiration of a previous call leading to resources being torn down. This is due to the resource sharing nature of cellular networks versus dedicated resources in conventional two-way radio networks. Disadvantageously, such situations require subsequent calls to once again set up a channel leading to a time delay for the user (e.g., several hundred milliseconds). Accordingly, there is a need for a system and method to minimize this time delay.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a network diagram of a wireless system with various mobile devices communicatively coupled to one or more wireless networks in accordance with some embodiments.

FIG. 2 is a flow diagram of a conventional push-to-talk (PTT) method such as with the wireless system of FIG. 1 in accordance with some embodiments.

FIG. 3 is a flow diagram of push-to-talk (PTT) method such as with the wireless system of FIG. 1 in accordance with some embodiments.

FIG. 4 is a flow diagram of a comparison of the PTT method of FIG. 2 with the PTT method of FIG. 3 showing PTT conversations between a mobile device and a Long Term Evolution (LTE) mobile device in accordance with some embodiments.

FIG. 5 is a flowchart of a mobile device-based method for parallel traffic channel (TCH) setup and floor request/floor grant processing by a controller in accordance with some embodiments.

FIG. 6 is a flowchart of a mobile device-based method for PTT affiliation and entering an idle state in push-to-talk over cellular (PoC) operation in accordance with some embodiments.

FIG. 7 is a flowchart of a controller and wireless network-based method in accordance with some embodiments.

FIG. 8 is a flowchart of another controller and wireless network-based method in accordance with some embodiments.

FIG. 9 is a block diagram of a controller for use in the wireless system of FIG. 1 and the various methods described herein in accordance with some embodiments.

FIG. 10 is a block diagram of a mobile device for use in the wireless system of FIG. 1 and the various methods described herein in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

In an exemplary embodiment, a mobile device-based method includes, in an idle state on a traffic channel of a wireless network, transitioning to a connected state on the traffic channel; sending a push-to-talk (PTT) floor request to a controller over a signaling channel on the wireless network prior to the transitioning to the connected state such that the traffic channel is set up in parallel with the PTT floor request processing by the controller; and subsequent to the transitioning to the connected state, receiving a floor grant from the controller.

In another exemplary embodiment, a controller and wireless network-based method includes receiving a PTT floor request from a mobile device over a signaling channel on a wireless network prior to the mobile device transitioning to a connected state; initiating a glare timer in the wireless network to avoid paging the mobile device for other incoming messages; transmitting a floor grant from the controller and buffering the floor grant in the wireless network until the mobile device is in the connected state; and transmitting the buffered floor grant to the mobile device and removing the glare timer upon the mobile device entering the connected state.

In yet another exemplary embodiment, a mobile device includes a network interface communicatively coupled to a wireless network; a processor communicatively coupled to the network interface; and memory storing instructions that, when executed, cause the processor and the network interface to: receive a PTT request; transition to a connected state on a traffic channel of a wireless network; send a push-to-talk floor request to a controller over a signaling channel on the wireless network prior to transitioning to the connected state such that the traffic channel is set up in parallel with processing of the PTT floor request by the controller; and subsequent to the transitioning to the connected state, receive a floor grant from the controller.

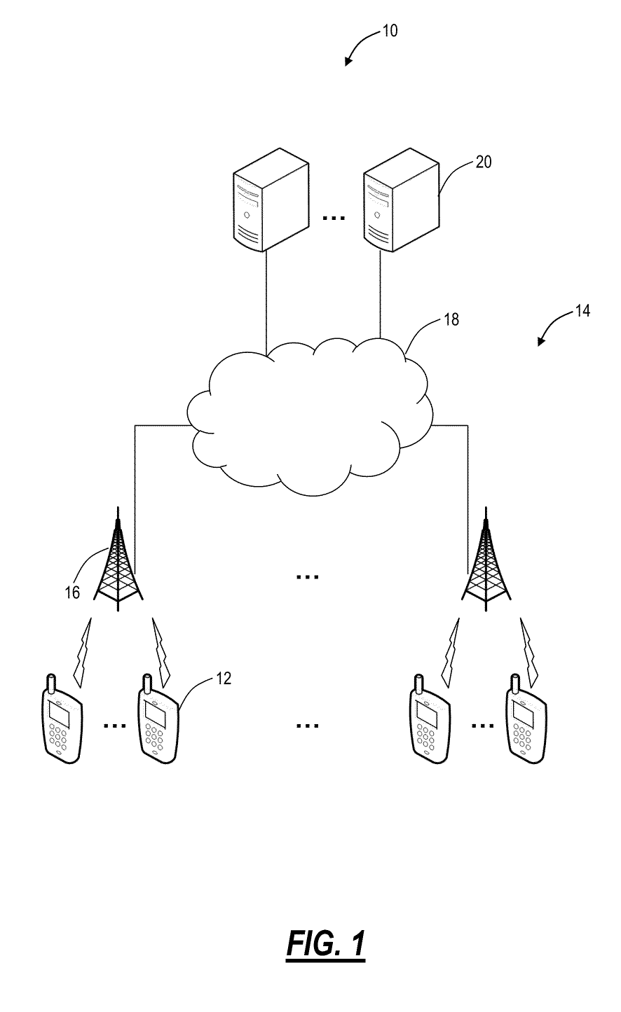

Referring to FIG. 1, in an exemplary embodiment, a network diagram illustrates a wireless system 10 with various mobile devices 12 communicatively coupled to one or more wireless networks 14. The wireless networks 14 generally include wireless stations 16, i.e. base stations, which provide wireless connectivity over a geographic region to the mobile devices 12 within wireless range. The wireless stations 16 are communicatively coupled therebetween via a backhaul network 18 which may connect to various other networks such as the Internet, a local area network (LAN), a virtual private network (VPN), and the like. In the context of the wireless system 10, the backhaul network 18 can be communicatively coupled to one or more controllers 20, either directly or through one or more additional networks such as the Internet. In an exemplary embodiment, the wireless stations 16 can operate in accordance with CDMA, and the controller 20 can be a push-to-talk (PTT) controller for PTT operations over a broadband network. The wireless system 10 can include systems and methods using Data over Signaling in wireless networks for maintaining connections that enable 300-400 ms improvements in PTT setup for dormant channels as is described herein.

In an exemplary operation, the mobile devices 12 can be performing PTT over the wireless networks 14 with the various mobile devices 12 affiliated with one or more groups. For example, affiliation can occur through Session Initiation Protocol (SIP) using SIP INVITE messages. In an exemplary embodiment, the wireless networks 14 can be operating in accordance with CDMA DO Rev A (TIA-856-A) or variants thereof. When one of the mobile devices 12 is affiliated to a group, the mobile device 12 may be dormant (e.g., a hang timer for a previous group call has expired, resources have been torn down, etc.) and then the user of the mobile device 12 may press the PTT button to “start a group call.” As described herein, conventionally, this requires the mobile device 12 to set up a data channel over the wireless network 14 (i.e., transition from idle to a connected state) and then send a floor request over the data channel to the controller 20 to obtain the floor in the group call.

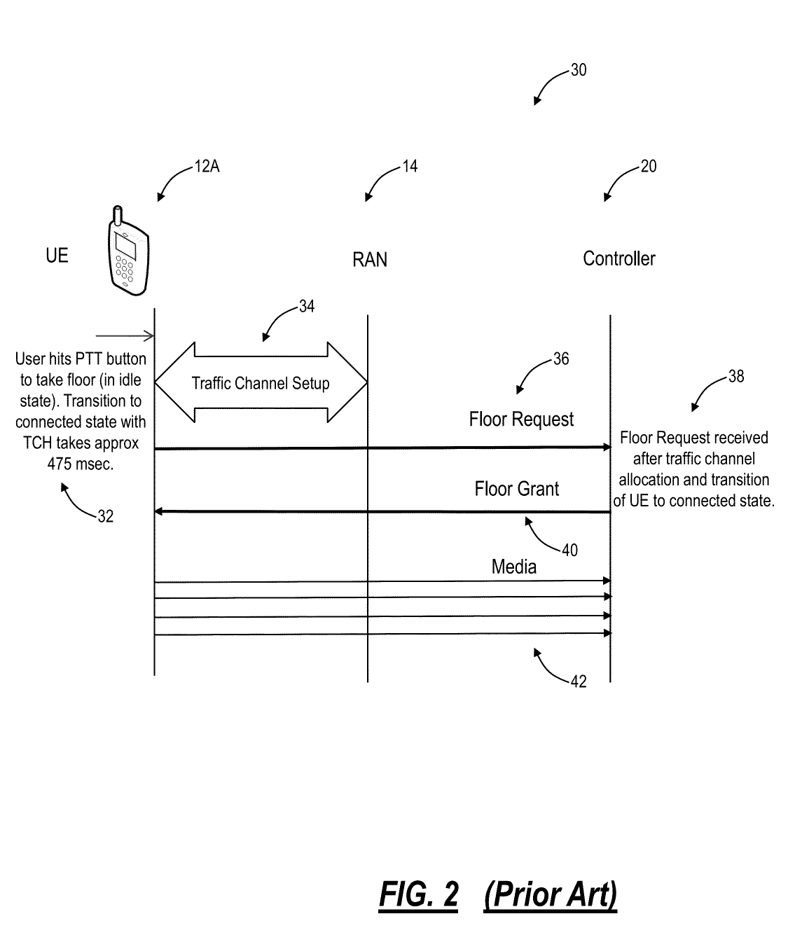

Referring to FIG. 2, in a conventional embodiment, a flow diagram illustrates a conventional PTT method 30 such as with the wireless system 10. In context of the PTT method 30, it is assumed a mobile device 12A is affiliated with a group, in the idle state with the group, and a user of the mobile device 12A wishes to take the floor. Note, the mobile device 12A can also be referred to as User Equipment (UE). First, the user enables PTT to take the floor (step 32). This can include the user hitting a PTT button or equivalent thereof on the mobile device 12A. Upon activating the PTT to take the floor, traffic channel (TCH) setup is performed between the mobile device 12A and the wireless network 14 (denoted as a radio access network (RAN)) (step 34). It is expected that the TCH setup takes approximately 475 msec. The mobile device 12A sends a floor request over the wireless network 14 to the controller 20 (step 36).

The controller 20 receives the floor request, and after performing traffic channel allocation and transitioning of the mobile device 12A to a connected state (step 38), the controller 20 sends a floor grant to the mobile device 12A over the wireless network 14 (step 40). Subsequent to receipt of the floor grant, the mobile device 12A can operate on the PTT channel over the wireless network 14 (step 42). Hence, the conventional PTT method 30 involves a “hit” in the time required to transition the mobile device 12A from an idle state to a connected state over the wireless network 14. This “hit” can be defined as the TCH setup time (e.g., 475 msec) plus the additional time to perform steps 36, 38, 40. Note, in the conventional PTT method 30, the steps 34, 36, 38, 40 are performed serially leading to additional delay hampering user experience. Further, since it is likely the user of the mobile device 12A is not talking continuously on the PTT channel, the mobile device 12A is typically going to be in the idle state when the user wishes to take the floor. Thus, this “hit” can be experienced often by the user of the mobile device 12A.

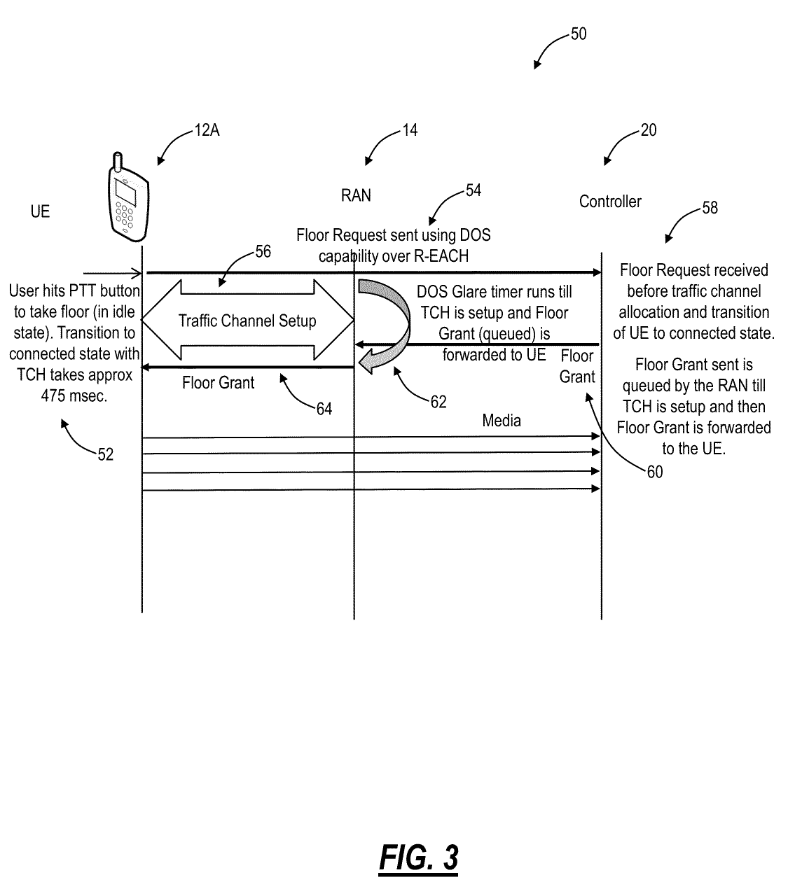

Referring to FIG. 3, in an exemplary embodiment, a flow diagram illustrates a PTT method 50 such as with the wireless system 10. In context of the PTT method 50 and similar to the PTT method 30, it is assumed a mobile device 12A is affiliated with a group, in the idle state with the group, and a user of the mobile device 12A wishes to take the floor. However, relative to the PTT method 30, the PTT method 50 provides the floor request in parallel with the TCH setup to reduce overall setup time and improve user experience by minimizing the “hit” in the PTT method 30. Again, similar to the PTT method 30, the PTT method 50 includes the user of the mobile device 12A enabling PTT to take the floor (step 52). This can include the user hitting a PTT button or equivalent thereof on the mobile device 12A. Subsequently, a floor request is sent to the controller 20 over the wireless network 14 immediately (or any time after the TCH setup begins but before the TCH setup completes) using a signaling capability of the wireless network 14 (step 54) while concurrently having the mobile device 12A enter TCH setup (step 56). The goal here is to perform the TCH setup in parallel with the floor request/floor grant setup with the controller 20.

The controller 20 receives the floor request from the mobile device 12A before the TCH setup, i.e. before traffic channel allocation and transition of the mobile device 12A to a connected state (step 58). Concurrent with the TCH setup process, the controller sends a floor grant which is queued by the wireless network 14 until the TCH is setup (step 60). The wireless network 14 can include a glare timer that runs until the TCH is setup and the floor grant is queued (step 62). Once the TCH is setup, the floor grant is forwarded to the mobile device 12A (step 64). Thus, the floor request from the mobile device 12A shall be received at the controller 20 and floor grant shall be sent while the traffic channel setup is in progress. Relative to the PTT method 30, the PTT method 50 reduces the “hit” performing the TCH setup in parallel with the floor request/floor grant.

In step 54, the PTT method 50 uses a signaling capability of the wireless network 14 to immediately send the floor request to the controller 20 with having the TCH setup. In an exemplary embodiment, this signaling capability can include the Data over Signaling (DOS) capability (3GPP2 CDMA DO Rev A standard feature) over the R-EACH (Reverse Enhanced Access Channel). Alternatively, this signaling capability can be any signaling channel in CDMA and variants thereof, Global System for Mobile Communications (GSM) and variants thereof, LTE and variants thereof, etc.

A floor request is generally a request by the mobile device 12A to obtain the floor on a channel. The Open Mobile Alliance (OMA) Talk Burst Control Protocol (TBCP) floor request message is defined in Section 6.5.2 of OMA-TS_PoC-UserPlane-V1_{—}0-20060127-C (2006) (available online at www.openmobilealliance.org/Technical/release_program/docs/PoC/V1_{—}0-20060127-C/OMA-TS-PoC-UserPlane-V1_{—}0-20060127-C.pdf). The TBCP floor request has a twelve byte header followed by open or more “option fields.” For OMA Push-to-Talk over Cellular (POC) usage, there are two option fields defined, namely a Talk burst priority level of three bytes and a Talk burst request time stamp of ten bytes. In an exemplary embodiment, this floor request is constructed as defined by the OMA PoC User Plane document such that the size of the payload is less than 36 bytes. This allows the mobile device 12A to send the floor request in three Access Channel (ACH) frames (36 bytes is the upper limit of User Datagram Protocol (UDP) payload for 3 ACH frames).

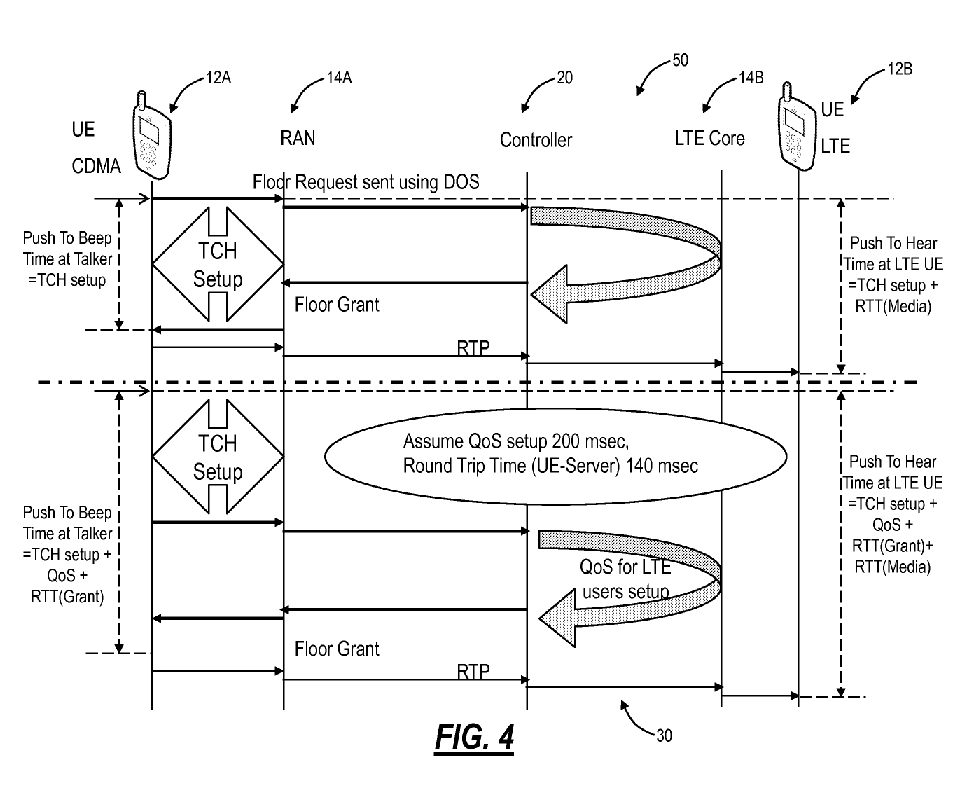

Referring to FIG. 4, in an exemplary embodiment a flow diagram illustrates a comparison of the PTT method 30 with the PTT method 50 showing PTT conversations between the mobile device 12A and an LTE mobile device 12B. Specifically, the PTT method 50 is illustrated on top and the PTT method 30 is illustrated on the bottom. The mobile device 12B, in this example, is an LTE client communicating on an LTE core wireless network 14B. The mobile device 12A, in this example, is a CDMA device communicating on a radio access network 14A. In the PTT method 50, the mobile device 12A experiences a push-to-beep time equal to the TCH setup time. This is due to the parallel nature of setting up the floor with the controller 20 over DOS. The mobile device 12B experiences a push-to-hear time equal to the TCH setup time plus a round trip transit (RTT) time of the media to get from the mobile device 12A to the mobile device 12B over Real Time Protocol (RTP).

With the PTT method 30, the push-to-beep time at the mobile device 12B is equal to the TCH setup time plus a Quality of Service (QoS) setup time for the LTE mobile device 12B plus the RTT of the floor request and floor grant. The push-to-hear time at the mobile device 12B is equal to the TCH setup plus the QoS setup time plus the RTT of the floor request and floor grant plus the RTT of the media to get from the mobile device 12A to the mobile device 12B over Real Time Protocol (RTP).

Thus, without the systems and methods described herein, the push-to-beep time is equal to: TCH setup+QoS setup+RTT. With the systems and methods described herein, the push-to-beep time is equal to: MAX {TCH setup, RTT+QoS setup}. The systems and methods described herein provide a benefit (i.e., reduction in time) equal to: if TCH Setup >(RTT+QoS) then the benefit equals QoS setup+RTT time, or if TCH Setup <(RTT+QoS) then the benefit equals the TCH Setup time.

Assume for comparison purposes, that the TCH setup time is approximately 475 msec, the RTT setup time between the mobile device 12A and the controller 20 is 140 msec, and the QoS setup on LTE is approximately 200 msec. Based on the foregoing, the systems and methods described herein reduce the hit by approximately 340 msec which is a noticeable amount in context of user experience.

Of note, the various exemplary embodiments described herein include the floor request from the mobile device 12 followed by the floor grant from the controller 20. However, the controller 20 may not respond with a floor grant. The controller 20 can respond with a floor deny denying the floor to the mobile device 12, a floor taken indicating someone else has taken the floor (and likely followed with a floor deny), a floor revoke such as if the mobile device 12 is the only device in the call, a request queue status indicating that mobile device 12's talk burst request has been queued (e.g., a higher priority user is talking and cannot be preempted to give the floor to the mobile device 12), and the like. In the various systems and methods described herein, the aforementioned messages can be provided by the controller 20 in lieu of the floor grant. Note, these messages can be provided in a similar manner as the floor grant, and the systems and methods described herein still allow the mobile device 12 to receive these messages in an expedited manner and for remedial actions based thereon.

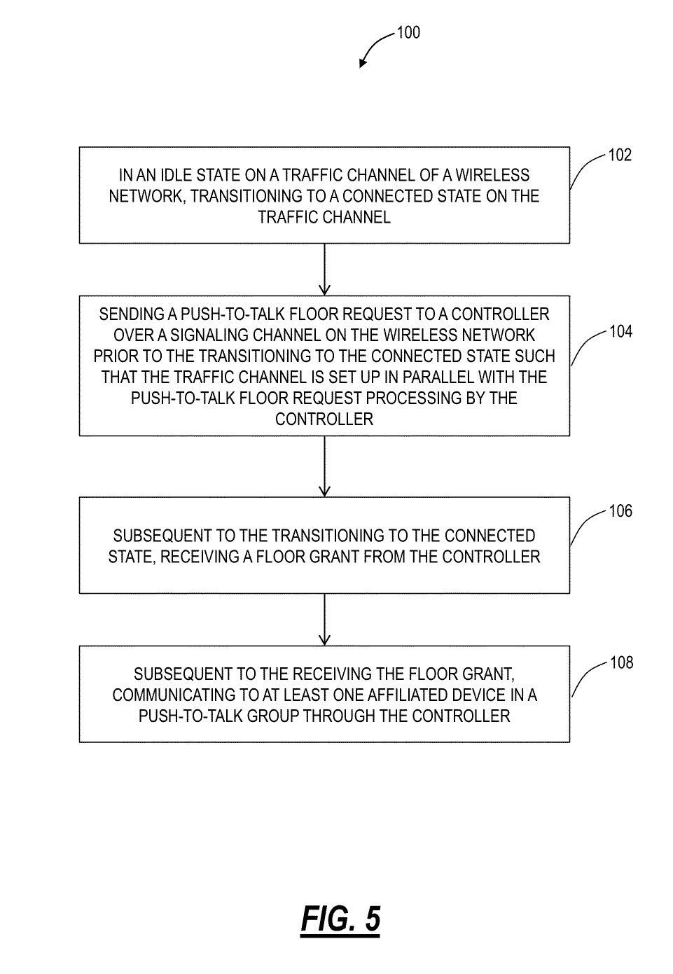

Referring to FIG. 5, in an exemplary embodiment, a flowchart illustrates a mobile device-based method 100 for parallel TCH setup and floor request/floor grant processing by a controller. The mobile device-based method 100 includes, in an idle state on a traffic channel of a wireless network, transitioning to a connected state on the traffic channel (TCH) (step 102). The mobile device-based method 100 includes sending a push-to-talk floor request to a controller over a signaling channel on the wireless network prior to the transitioning to the connected state such that the traffic channel is set up in parallel with the push-to-talk floor request processing by the controller (step 104). The mobile device-based method 100 further includes, subsequent to the transitioning to the connected state, receiving a floor grant from the controller (step 106). The mobile device-based method 100 can also include, subsequent to the receiving the floor grant, communicating to at least one affiliated device in a push-to-talk group through the controller (step 108).

In an exemplary embodiment of the mobile device-based method 100, the mobile device communicates on the wireless network utilizing Code Division Multiple Access or variants thereof, and wherein the signaling channel comprises Data Over Signaling (DOS) using Reverse Enhanced Access Channel (R-EACH frames). Prior to the transitioning to the connected state, the floor grant is buffered by one of the wireless network and the controller. Subsequent to the transitioning to the connected state, the floor grant is immediately forwarded from a buffer. A Data Over Signaling (DOS) glare timer is initiated in the wireless network until the transitioning to the connected state to avoid paging of other incoming messages to the mobile device. Subsequent to the transitioning to the connected state, the floor grant is immediately forwarded from a buffer, and wherein the Data Over Signaling glare timer is terminated in the wireless network subsequent to the floor grant being forwarded. Note the glare timer is used by the wireless network to avoid paging the mobile device for other incoming messages to that mobile device (since the mobile device is already setting up the traffic channel).

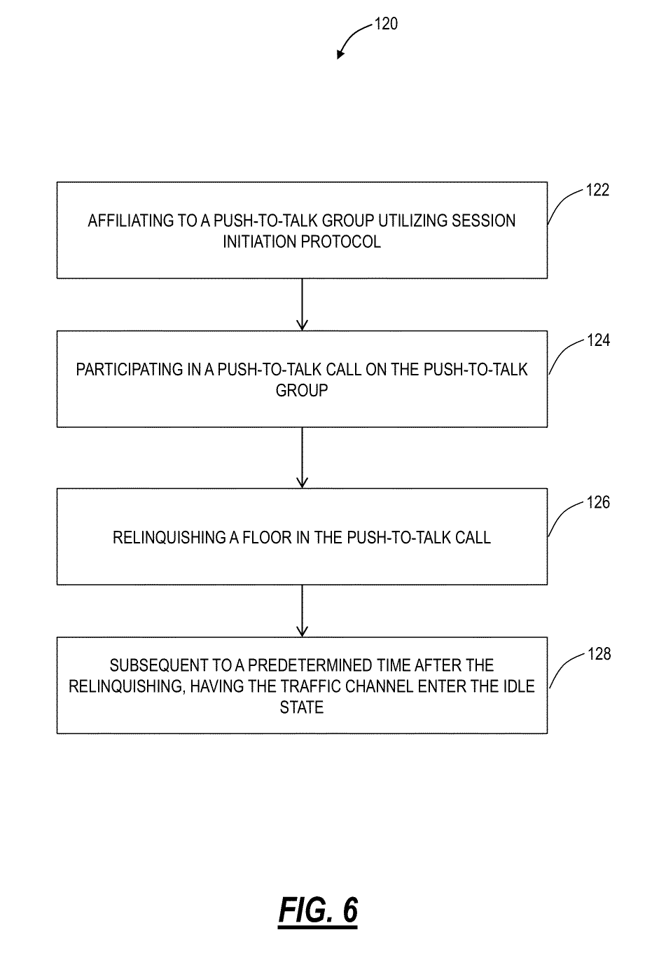

Referring to FIG. 6, in an exemplary embodiment, a flowchart illustrates a mobile device-based method 120 for PTT affiliation and entering an idle state in PoC operation. Specifically, the mobile device-based method 120 is performed in conjunction with the mobile device-based method 100. The mobile device-based method 120 includes affiliating to a push-to-talk group utilizing Session Initiation Protocol (step 122). The mobile device-based method 120 includes participating in a push-to-talk call on the push-to-talk group (step 124). The mobile device-based method 120 further includes relinquishing a floor in the push-to-talk call (step 126). Finally, the mobile device-based method 120 includes, subsequent to a predetermined time after the relinquishing, having the traffic channel enter the idle state (step 128). The mobile device-based method 120 can be performed before or after the mobile device-based method 100.

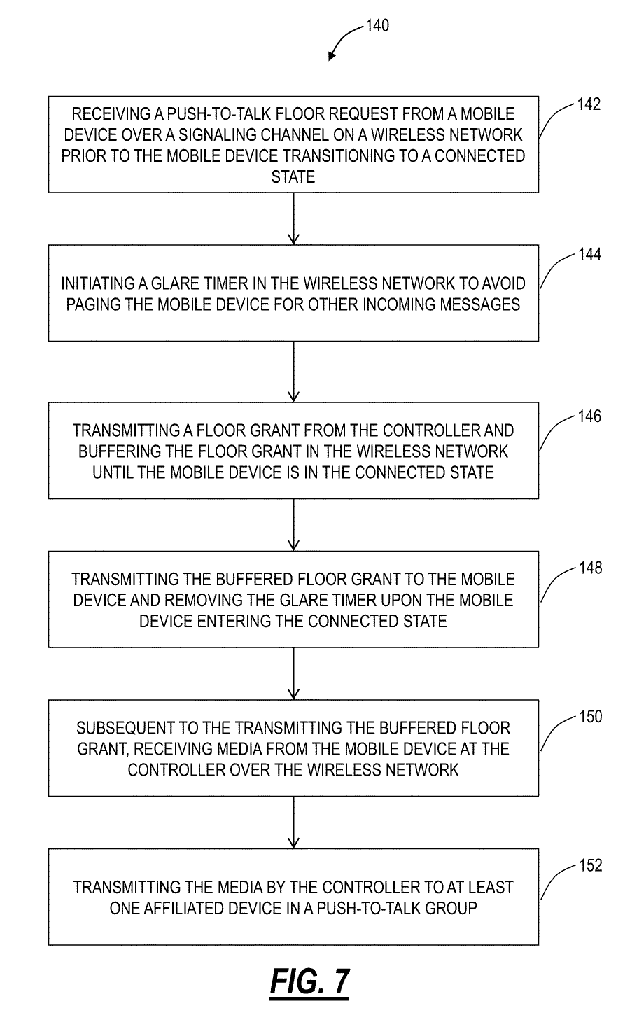

Referring to FIG. 7, in an exemplary embodiment, a flowchart illustrates a controller and wireless network-based method 140. The controller and wireless network-based method 140 includes receiving a push-to-talk floor request from a mobile device over a signaling channel on a wireless network prior to the mobile device transitioning to a connected state (step 142). The controller and wireless network-based method 140 includes initiating a glare timer in the wireless network to avoid paging the mobile device for other incoming messages (step 144). The controller and wireless network-based method 140 further includes transmitting a floor grant from the controller and buffering the floor grant in the wireless network until the mobile device is in the connected state (step 146). The controller and wireless network-based method 140 includes transmitting the buffered floor grant to the mobile device and removing the glare timer upon the mobile device entering the connected state (step 148).

The controller and wireless network-based method 140 can also include, subsequent to the transmitting the buffered floor grant, receiving media from the mobile device at the controller over the wireless network (step 150). Finally, the controller and wireless network-based method 140 can also include transmitting the media by the controller to at least one affiliated device in a push-to-talk group (step 152). In an exemplary embodiment, the mobile device communicates on the wireless network utilizing Code Division Multiple Access or variants thereof, and wherein the signaling channel comprises Data Over Signaling (DOS) using Reverse Enhanced Access Channel (R-EACH frames).

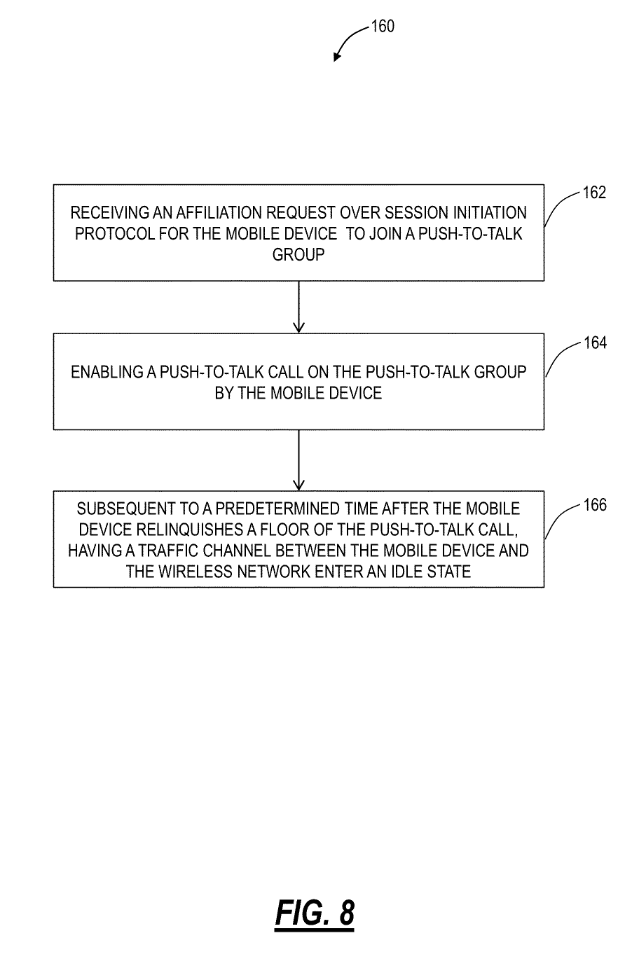

Referring to FIG. 8, in an exemplary embodiment, a flowchart illustrates a controller and wireless network-based method 160. The controller and wireless network-based method 160 includes receiving an affiliation request over Session Initiation Protocol for the mobile device to join a push-to-talk group (step 162). The controller and wireless network-based method 160 includes enabling a push-to-talk call on the push-to-talk group by the mobile device (step 164). Finally, the controller and wireless network-based method 160 includes, subsequent to a predetermined time after the mobile device relinquishes a floor of the push-to-talk call, having a traffic channel between the mobile device and the wireless network enter an idle state.

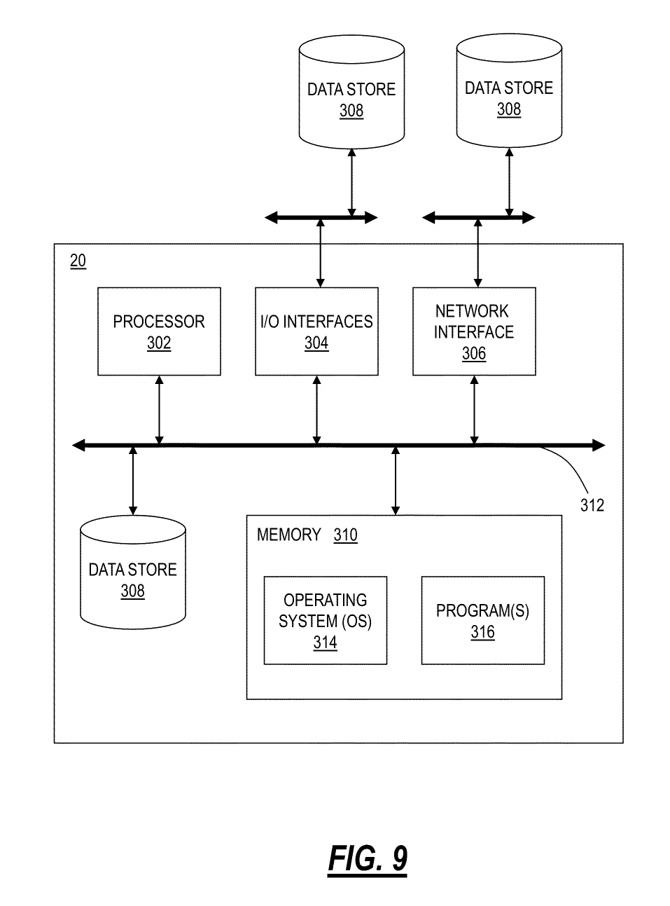

Referring to FIG. 9, in an exemplary embodiment, a block diagram illustrates the controller 20 for use in the wireless system 10 and the various methods described herein. The controller 20 can be a digital computer that, in terms of hardware architecture, generally includes a processor 302, input/output (I/O) interfaces 304, a network interface 306, a data store 308, and memory 310. It should be appreciated by those of ordinary skill in the art that FIG. 9 depicts the controller 20 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 can be, for example but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 can include address, control, and/or data connections to enable appropriate communications among the aforementioned components.

The processor 302 is a hardware device for executing software instructions. The processor 302 can be any custom made or commercially available processor, a central processing unit (CPU), an auxiliary processor among several processors associated with the controller 20, a semiconductor-based microprocessor (in the form of a microchip or chip set), or generally any device for executing software instructions. When the controller 20 is in operation, the processor 302 is configured to execute software stored within the memory 310, to communicate data to and from the memory 310, and to generally control operations of the controller 20 pursuant to the software instructions. The I/O interfaces 304 can be used to receive user input from and/or for providing system output to one or more devices or components. User input can be provided via, for example, a keyboard, touch pad, and/or a mouse. System output can be provided via a display device and a printer (not shown). I/O interfaces 304 can include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 can be used to enable the controller 20 to communicate on a network, such as the backhaul network 18. The network interface 306 can include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 can include address, control, and/or data connections to enable appropriate communications on the network. A data store 308 can be used to store data. The data store 308 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 can incorporate electronic, magnetic, optical, and/or other types of storage media. In one example, the data store 308 can be located internal to the controller 20 such as, for example, an internal hard drive connected to the local interface 312 in the controller 20. Additionally in another embodiment, the data store 308 can be located external to the controller 20 such as, for example, an external hard drive connected to the I/O interfaces 304 (e.g., SCSI or USB connection). In a further embodiment, the data store 308 can be connected to the controller 20 through a network, such as, for example, a network attached file server.

The memory 310 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 can incorporate electronic, magnetic, optical, and/or other types of storage media. Note that the memory 310 can have a distributed architecture, where various components are situated remotely from one another, but can be accessed by the processor 302. The software in memory 310 can include one or more software programs, each of which includes an ordered listing of executable instructions for implementing logical functions. The software in the memory 310 includes a suitable operating system (O/S) 314 and one or more programs 316. The operating system 314 essentially controls the execution of other computer programs, such as the one or more programs 316, and provides scheduling, input-output control, file and data management, memory management, and communication control and related services. The one or more programs 316 may be configured to implement the various processes, algorithms, methods, techniques, etc. described herein. For example, the programs 316 can be configured to enable the methods described herein.

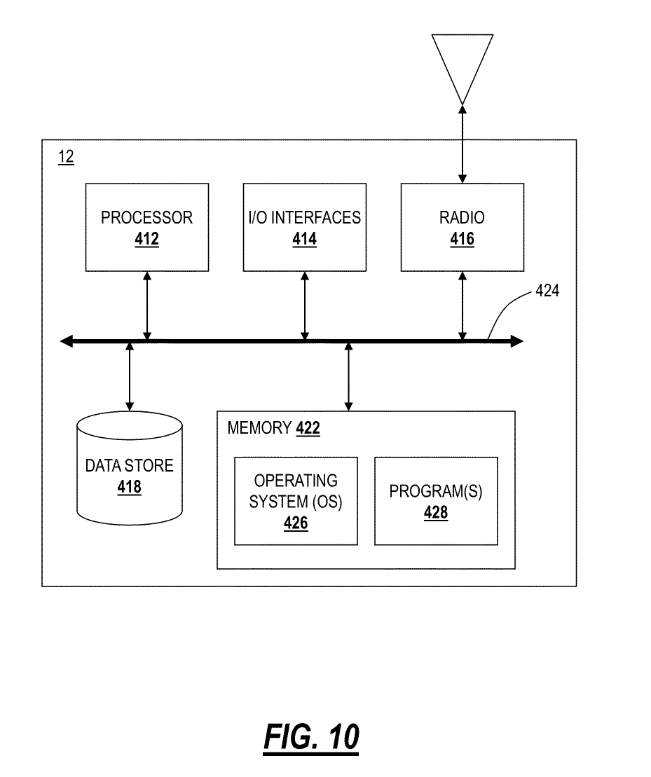

Referring to FIG. 10, in an exemplary embodiment, a block diagram illustrates the mobile device 12 for use in the wireless system 10 and the various methods described herein. The mobile device 12 can be a digital device that, in terms of hardware architecture, generally includes a processor 412, input/output (I/O) interfaces 414, a radio 416, a data store 418, and memory 422. It should be appreciated by those of ordinary skill in the art that FIG. 10 depicts the mobile device 12 in an oversimplified manner, and a practical embodiment can include additional components and suitably configured processing logic to support known or conventional operating features that are not described in detail herein. The components (412, 414, 416, 418, and 422) are communicatively coupled via a local interface 424. The local interface 424 can be, for example but not limited to, one or more buses or other wired or wireless connections, as is known in the art. The local interface 424 can have additional elements, which are omitted for simplicity, such as controllers, buffers (caches), drivers, repeaters, and receivers, among many others, to enable communications. Further, the local interface 424 may include address, control, and/or data connections to enable appropriate communications among the aforementioned components.

The processor 412 is a hardware device for executing software instructions. The processor 412 can be any custom made or commercially available processor, a central processing unit (CPU), an auxiliary processor among several processors associated with the mobile device 12, a semiconductor-based microprocessor (in the form of a microchip or chip set), or generally any device for executing software instructions. When the mobile device 12 is in operation, the processor 412 is configured to execute software stored within the memory 422, to communicate data to and from the memory 422, and to generally control operations of the mobile device 12 pursuant to the software instructions. In an exemplary embodiment, the processor 412 may include a mobile optimized processor such as optimized for power consumption and mobile applications. The I/O interfaces 414 can be used to receive user input from and/or for providing system output. User input can be provided via, for example, a keypad, a touch screen, a scroll ball, a scroll bar, buttons, bar code scanner, and the like. System output can be provided via a display device such as a liquid crystal display (LCD), touch screen, and the like. The I/O interfaces 414 can also include, for example, a serial port, a parallel port, a small computer system interface (SCSI), an infrared (IR) interface, a radio frequency (RF) interface, a universal serial bus (USB) interface, and the like. The I/O interfaces 414 can include a graphical user interface (GUI) that enables a user to interact with the mobile device 12 Additionally, the I/O interfaces 414 may further include an imaging device, i.e. camera, video camera, etc.

The radio 416 enables wireless communication to an external access device or network. Any number of suitable wireless data communication protocols, techniques, or methodologies can be supported by the radio 416, including, without limitation: RF; LMR; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 418 can be used to store data. The data store 418 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 418 can incorporate electronic, magnetic, optical, and/or other types of storage media.

The memory 422 can include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 422 may incorporate electronic, magnetic, optical, and/or other types of storage media. Note that the memory 422 can have a distributed architecture, where various components are situated remotely from one another, but can be accessed by the processor 412. The software in memory 422 can include one or more software programs, each of which includes an ordered listing of executable instructions for implementing logical functions. In the example of FIG. 10, the software in the memory 422 includes a suitable operating system (O/S) 426 and programs 428. The operating system 426 essentially controls the execution of other computer programs, and provides scheduling, input-output control, file and data management, memory management, and communication control and related services. The programs 428 can include various applications, add-ons, etc. configured to provide end user functionality with the mobile device 12. For example, exemplary programs 428 can include, but not limited to, a web browser, social networking applications, streaming media applications, games, mapping and location applications, electronic mail applications, financial applications, and the like.

In an exemplary embodiment, the mobile device includes a network interface communicatively coupled to a wireless network; a processor communicatively coupled to the network interface; and memory storing instructions that, when executed, cause the processor and the network interface to perform various functions. Specifically, the instructions that, when executed, cause the processor and the network interface to receive a push-to-talk request; transition to a connected state on a traffic channel of a wireless network; send a push-to-talk floor request to a controller over a signaling channel on the wireless network prior to transitioning to the connected state such that the traffic channel is set up in parallel with processing of the push-to-talk floor request by the controller; and subsequent to the transitioning to the connected state, receive a floor grant from the controller.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A mobile device-based method, comprising:
in an idle state on a traffic channel of a wireless network, transitioning to a connected state on the traffic channel;
sending a push-to-talk floor request to a controller over a signaling channel on the wireless network prior to the transitioning to the connected state such that the traffic channel is set up in parallel with the push-to-talk floor request processing by the controller; and
subsequent to the transitioning to the connected state, receiving a floor grant from the controller.

2. The mobile device-based method of claim 1, further comprising:
subsequent to the receiving the floor grant, communicating to at least one affiliated device in a push-to-talk group through the controller.

3. The mobile device-based method of claim 1, further comprising:
affiliating to a push-to-talk group utilizing Session Initiation Protocol;
participating in a push-to-talk call on the push-to-talk group;
relinquishing a floor in the push-to-talk call; and
subsequent to a predetermined time after the relinquishing, having the traffic channel enter the idle state.

4. The mobile device-based method of claim 1, wherein the mobile device communicates on the wireless network utilizing Code Division Multiple Access or variants thereof, and wherein the signaling channel comprises Data Over Signaling (DOS) using Reverse Enhanced Access Channel (R-EACH frames).

5. The mobile device-based method of claim 4, wherein, prior to the transitioning to the connected state, the floor grant is buffered by one of the wireless network and the controller.

6. The mobile device-based method of claim 5, wherein, subsequent to the transitioning to the connected state, the floor grant is immediately forwarded from a buffer.

7. The mobile device-based method of claim 4, wherein a Data Over Signaling glare timer is initiated in the wireless network until the transitioning to the connected state to avoid paging of other incoming messages to the mobile device.

8. The mobile device-based method of claim 7, wherein, subsequent to the transitioning to the connected state, the floor grant is immediately forwarded from a buffer, and wherein the Data Over Signaling glare timer is terminated in the wireless network subsequent to the floor grant being forwarded.

9. A controller and wireless network-based method, comprising:
receiving a push-to-talk floor request from a mobile device over a signaling channel on a wireless network prior to the mobile device transitioning to a connected state;
initiating a glare timer in the wireless network to avoid paging the mobile device for other incoming messages;
transmitting a floor grant from the controller and buffering the floor grant in the wireless network until the mobile device is in the connected state; and
transmitting the buffered floor grant to the mobile device and removing the glare timer upon the mobile device entering the connected state.

10. The controller and wireless network-based method of claim 9, further comprising:
subsequent to the transmitting the buffered floor grant, receiving media from the mobile device at the controller over the wireless network; and
transmitting the media by the controller to at least one affiliated device in a push-to-talk group.

11. The controller and wireless network-based method of claim 9, further comprising:
receiving an affiliation request over Session Initiation Protocol for the mobile device to join a push-to-talk group;
enabling a push-to-talk call on the push-to-talk group by the mobile device; and
subsequent to a predetermined time after the mobile device relinquishes a floor of the push-to-talk call, having a traffic channel between the mobile device and the wireless network enter an idle state.

12. The controller and wireless network-based method of claim 9, wherein the mobile device communicates on the wireless network utilizing Code Division Multiple Access or variants thereof, and wherein the signaling channel comprises Data Over Signaling (DOS) using Reverse Enhanced Access Channel (R-EACH frames).

13. A mobile device, comprising:
a network interface communicatively coupled to a wireless network;
a processor communicatively coupled to the network interface; and
memory storing instructions that, when executed, cause the processor and the network interface to:
receive a push-to-talk request;
transition to a connected state on a traffic channel of a wireless network;
send a push-to-talk floor request to a controller over a signaling channel on the wireless network prior to transitioning to the connected state such that the traffic channel is set up in parallel with processing of the push-to-talk floor request by the controller; and
subsequent to the transitioning to the connected state, receive a floor grant from the controller.

14. The mobile device of claim 13, wherein the instructions that, when executed, further cause the processor and the network interface to:
subsequent to the receiving the floor grant, communicate to at least one affiliated device in a push-to-talk group through the controller.

15. The mobile device of claim 13, wherein the instructions that, when executed, further cause the processor and the network interface to:
affiliate to a push-to-talk group utilizing Session Initiation Protocol;
participate in a push-to-talk call on the push-to-talk group;
relinquish a floor in the push-to-talk call; and
subsequent to a predetermined time after the relinquishing, have the traffic channel enter the idle state.

16. The mobile device of claim 13, wherein the mobile device communicates on the wireless network utilizing Code Division Multiple Access or variants thereof, and wherein the signaling channel comprises Data Over Signaling (DOS) using Reverse Enhanced Access Channel (R-EACH frames).

17. The mobile device of claim 16, wherein, prior to the transitioning to the connected state, the floor grant is buffered by one of the wireless network and the controller.

18. The mobile device of claim 17, wherein, subsequent to the transitioning to the connected state, the floor grant is immediately forwarded from a buffer.

19. The mobile device of claim 16, wherein a Data Over Signaling glare timer is initiated in the wireless network until the transitioning to the connected state to avoid paging of other incoming messages to the mobile device.

20. The mobile device of claim 19, wherein, subsequent to the transitioning to the connected state, the floor grant is immediately forwarded from a buffer, and wherein the Data Over Signaling glare timer is terminated in the wireless network subsequent to the floor grant being forwarded.
